(19) United States
(12) Patent Application Publication
(10) Pub. No.: US 2025/0111375 A1
(43) Pub. Date: Apr. 3, 2025

(54) CROWD-SOURCED FRAUD DETECTION FOR REMOTE TRANSACTIONS

(71) Applicant: GeoComply Solutions Inc., Vancouver (CA)

(72) Inventors: Anh Dinh, San Francisco, CA (US); Vladyslav Serzhantov, Vancouver (CA); Aliaksei Sukharevich, Warsaw (PL); Yevgeniia Ivanova, Warsaw (PL); Alexander Soiko, Kyiv (UA); Pawel Kabicz, Warsaw (PL); Levon Arutyunov, Kyiv (UA)

(21) Appl. No.: 18/480,215

(22) Filed: Oct. 3, 2023

(51) Int. Cl. G06Q 20/40

(52) U.S. Cl. CPC G06Q 20/4016; G06Q 20/4015

(57) ABSTRACT

Systems and methods relate to anti-fraud system and crowd-sourced fraud detection for remote transactions. Embodiments may include a database storing crowd-sourced, historical location data associated with one or more transactions, at least one verification unit, and a machine learning model trained on crowd-sourced historical location data associated with prior transactions. Various systems and methods may receive transaction information associated with a user, generate a spoofing metric based on a characteristic of historical location data, and generate a transaction score based on the spoofing metric. The transaction score may indicate a fraudulent transaction prediction.

### BACKGROUND

Remote transactions provide convenience and efficiency across various industries, enabling individuals to make purchases, conduct business, and engage in financial, personal, and business transactions from virtually anywhere. Many gaming, betting, and digital entertainment platforms provide remote options to allow individuals to play from the comfort of their home, while traveling, and without having to go to a physical gaming location.

Remote transactions often involve a complex interplay of real-world financial transfers, online activity, virtual entertainment platforms, and multiple, connected computing environments, making them susceptible to fraudulent activities. As these platforms and entertainment methods continue to gain popularity, fraud techniques become increasingly sophisticated. Traditional fraud detection and defense mechanisms often struggle to identify and adapt to deceptive transaction techniques, like location spoofing, and remain limited in their ability to dynamically identify and prevent a variety of spoofing methods.

In addition, many jurisdictions have specific laws and requirements for parties participating online gaming, betting, business, and remote transactions. The cross-jurisdictional nature of many remote transactions present additional challenges with respect to developing a robust, comprehensive approach, since such transactions often involve, for example, differing regulatory frameworks, technological adaptations, computing environments, and player behaviors.

### SUMMARY

Methods and systems disclosed herein relate to crowd-sourced fraud detection for remote transactions. Embodiments provide techniques to dynamically assess and mitigate fraudulent activities across a range of remote transactions and computing environments. In an example, a fraud detection system may include a database comparing historical location data associated with one or more transactions, a first verification unit generating a spoofing metric based on a characteristic of the historical location data, at least one processor, and a memory comprising instructions to be executed by the processor. The fraud detection system may receive transaction information associated with a user, apply the first verification unit to the transaction information to generate the spoofing metric, and generate a transaction score based on the spoofing metric, wherein the transaction score is indicative of a fraudulent transaction prediction.

According to various embodiments, the characteristic relates to at least one of IP data, Wi-Fi data, Wi-Fi Access Point Signal data, application data, sensor data, atmospheric pressure data, altitude data, satellite data, fingerprinting data, and fraudulent transaction data. The spoofing metric may be indicative of at least one of: an anomaly detection, a Wi-Fi score, a suspicion measurement, and a detection score. The historical location data may include crowd-sourced transaction data from a plurality of users. Historical location data may also include a collection of prior transactions associated with the user.

The first verification unit may generate the spoofing metric by generating a set of numerical features from the historical location data, applying a classification model to sort the numerical features, and comparing respective attributes of the transaction information to generate the spoofing metric. The set of numerical features may be associated with the characteristic. The spoofing metric may also be based on a cross-check of historical transactions originating from a same location as the transaction information.

In some examples, a plurality of verification units may respectively generate spoofing metrics. The plurality of spoofing may determine the transaction score. In some examples, a second verification unit generates a second spoofing metric based on a second characteristic of the historical location data. The transaction score may be determined by the first spoofing metric and the second spoofing metric. Spoofing metrics may be weighted differently in the determination of the transaction score. In some embodiments, generating the transaction score includes applying a machine learning model trained on historical location data. The machine learning model may be updated and re-trained based on the transaction information and the transaction score.

In additional examples, systems and methods may store location data from a user device in a database comprising historical location data associated with one or more transactions, and verify, in real-time, a consistency of the location data. The database may also be dynamically updated with new historical location data in real-time.

### BRIEF DESCRIPTION OF THE DRAWINGS

The following detailed description is better understood when read in conjunction with the appended drawing figures. For the purposes of illustration, examples are shown in the drawings; however, the subject matter is not limited to specific elements and instrumentalities disclosed.

FIG. 1 illustrates a flowchart diagram for an anti-fraud system including a transaction score determination.

FIG. 2 illustrates an architectural diagram for an anti-fraud system.

FIG. 3 illustrates an example diagram for VPN/Proxy detection.

FIG. 4 illustrates an example score transaction score determination.

FIG. 5 illustrates an example output for a Wi-Fi access points verification unit.

FIG. 6 illustrates an example classification output for feature comparison.

FIG. 7 illustrates an example distance distribution output for random and spoofed datasets.

FIG. 8 illustrates a flowchart for determining a transaction score.

FIG. 9 illustrates a flowchart for generating transaction scores.

FIG. 10 illustrates a cloud computing system in accordance with embodiments.

FIG. 11 illustrates an example computing device usable with embodiments.

FIG. 12 illustrates another example computing devices usable with embodiments.

### DETAILED DESCRIPTION OF ILLUSTRATIVE EMBODIMENTS

The present disclosure relates to anti-fraud systems and methods for assessing transactions. Various embodiments may utilize machine learning, artificial intelligence, and real-time data analysis techniques to analyze transaction data, determine anomalies relating to specific characteristics, and generate one or more spoofing metrics. A transaction score, based on the one or more spoofing metrics, may indicate a fraudulent transaction.

The anti-fraud techniques discussed herein provide, among other things, robust systems and methods to accurately detect and prevent fraudulent transactions. Embodiments may be scalable to handle large volumes of transactions and data, and may dynamically adapt, in real time, to learn from historical data. As such, spoofing metrics and transaction determinations may learn from previous attacks, known fraudulent transactions, spoofing attempts, and normal transactions and interactions. The flexible, modifiable architecture provides low latency, high throughput, and enables new techniques and analyses to be added to the anti-fraud system as they emerge.

Such techniques provide significant improvements over prior approaches and static assessments which address a single fraud or spoofing approach. Crowd-sourcing techniques, as discussed herein, enable a dynamic, multi-faceted assessment of prior transactions. Individual player behaviors may be analyzed to generate a personalized activity profile, usable to assess future behavior and potentially fraudulent activity. Crowd-sourced data may provide further information regarding one or more players and devices in one or more jurisdictions. The crowd-sourced information may be compared against a set of features relevant to a current transaction to determine a transaction score indicative of a likelihood of fraud or spoofing.

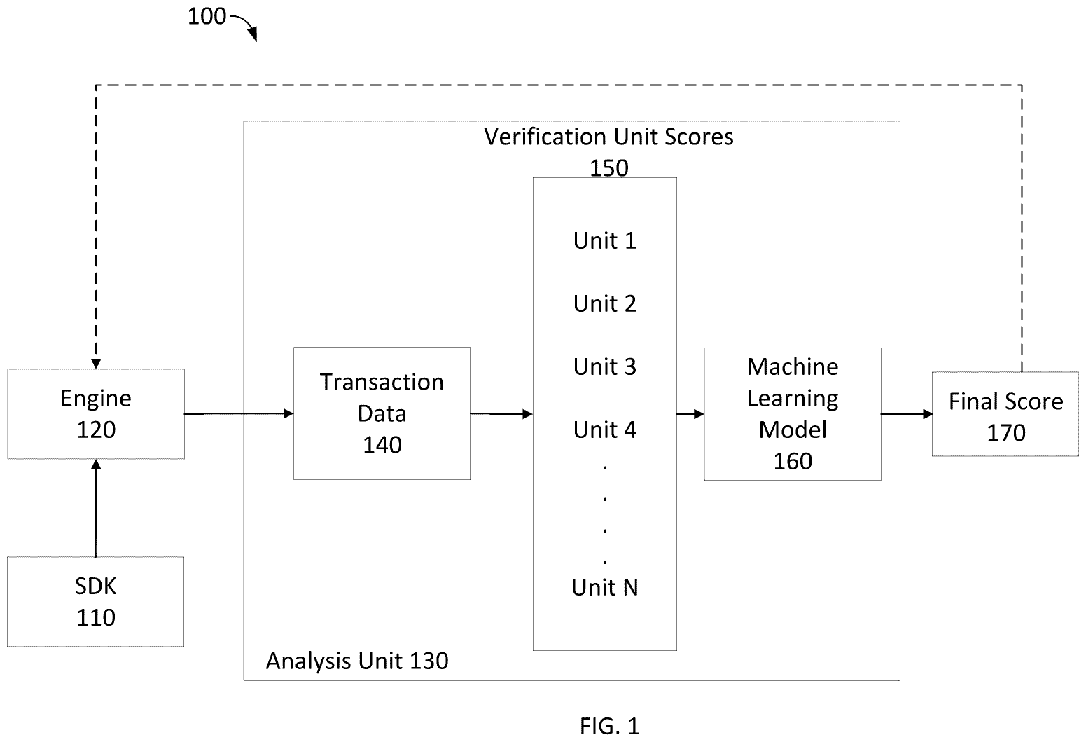

FIG. 1 illustrates a flowchart diagram for assessing fraud and generating a transaction score indicative of a likelihood of fraud. In an anti-fraud system 100, historical data may be assessed to generate scores related to anomalies or suspicious patterns. Location attributes of historical transactions, for example, may provide insights and patterns relating to normal usage and fraudulent attempts. As new transaction data is added, the anti-fraud system 100 may identify new patterns and generate new trends and insights to continually adapt to changing transaction methods, user behaviors, and other characteristics.

The anti-fraud system 100 utilizes at least one Verification Unit directed to a characteristic of the transaction data. The verification may, for example, relate to different types of data associated with the transaction, such as IP data, Wi-Fi data, Wi-Fi Access Point Signal (APS) data, altitude data, or other sensor data. Data from the verification unit(s) help generate an overall transaction score to indicate a likelihood of fraud. Scores from different verification units may be weighted differently to tailor the transaction assessment, e.g., to a particular business, transaction type, and/or field of use.

As illustrated in FIG. 1, a software development kit (SDK) 110 may provide a software foundation, including tools, libraries, documentation, and resources on which various transaction platforms, applications, and frameworks may be constructed. The SDK 110 may aid client integration and development processes to connect with and conduct the anti-fraud systems and methods discussed herein. The SDK 110 may connect with engine 120 to promote integration with other computing environments. As such, external clients, various software, applications, and services may integrate with the various systems and methods discussed herein and enable widespread applicability of embodiments with a plurality of clients, services, technologies, and business areas.

In various examples, the SDK 110 and/or the engine 120 may utilize an Application Programming Interface (API) through which users may interact with the anti-fraud services and functionalities. APIs may be customized and configured based on client requirements and preferences. For example, a dashboard may be provided on a user device or other graphical user interface or display associated with a computing device. Other aspects relating to behavior, appearance, or features may also be incorporated via the SDK 110 and engine 120. As discussed herein with respect to the various computing environments and architectures, the anti-fraud system 100 of FIG. 1 may be applied to one or more applications in a target environment, such as a user device, a server, or another computing device or computing platform.

The Analysis Unit 130 provides core features for a transaction score determination. The engine 120 provides Transaction Data 140, and the transaction data feeds into one or more verification units (e.g., Unit 1, Unit 2, . . . , Unit N) to generate Verification Unit Scores 150. In some examples, each verification unit provides an individual Verification Unit Score, which may be combined, compiled, aggregated, or otherwise compared with other Verification Unit Scores. In another example, the Verification Unit Scores 150 are a set of Verification Unit Scores from Units 1, 2, . . . , N.

Verification Units may analyze one or more aspects of the Transaction Data 140. For example, a Verification Unit may be tailored to analyze a particular type of data, including, but not limited to, one or more of a date, time, location, transaction type, IP data, Wi-Fi data, Wi-Fi APS data, application data, senor data, atmospheric pressure data, altitude data, satellite data, fingerprinting data, and fraudulent transaction data.

In some examples, a Verification Unit analyzes the transaction data through a comparison to historical data. The historical data may relate to one or more of similar transactions, previous transactions from a user, previous transactions from a similar demographic of users, flagged or suspicious transactions, spoofed transactions, and the like. Verification Units may utilize historical data to identify patterns, founded anomalies, suspicious behavior, normal behavior, and other attributes (e.g., location, usage, etc.) based on past usage.

In some examples, a Verification Unit may utilize one or more machine learning models to assess Transaction Data 140 and generate a Verification Unit Score. The machine learning model may, for example, assess historical data related to an aspect associated with the particular Verification Unit, determine comparative data from the Transaction Data 140, and perform a comparison of historical data and Transaction Data 140 to determine the Verification Unit Score. The Verification Unit Score may be representative of a spoofing metric indicative of a likelihood that the transaction is fraudulent or spoofed.

As an example, a Verification Unit relating to location may assess historical transaction data for a particular user, user device, gaming location, etc., and identify patterns related to where those transactions have occurred. For example, transaction data for a particular individual may demonstrate transactions recurring at particular locations, which may be associated with the individual's home or work. In some cases, the Verification Unit may further identify a time of day when the individual commonly plays at certain locations. The Verification Unit may identify these player patterns and then compare the Transaction Data 140 to those identified patterns and generate a Verification Score. If, for example, the Transaction Data identifies that the transaction occurred at a location outside of the identified pattern of prior locations—such as a different state or different country—the transaction may be spoofed, and the Unit Score will reflect that probability. On the other hand, if the Transaction Data 140 indicated that the transaction location was within the typical, known locations of prior transactions for that user, then the Verification Unit Score (e.g., spoofing metric) associated with location would reflect a score accounting for the likely normality of the transaction.

Verification Unit(s) may be usable to create profiles related to particular users and/or devices. Such profiles may serve as a comparison tool against a current transaction. In some examples, a user profile may contain information about one or more characteristics about online behavior, such as locations where the device is accessed, type of activity, time of access, etc. A device profile may provide additional information about device-related characteristics, such as the Wi-Fi data, Wi-Fi APS data, and sensor data, among others. Verifications Units associated with certain characteristics may create a profile regarding transaction behavior. The profile may be usable, in accordance with techniques described herein, to assess a current transaction related to that user and/or device.

The machine learning model 160 assesses Verification Unit Scores from the set of N Verification Units to generate a Final Score 170 representative of a transaction score indicative of a likelihood of a fraudulent transaction. The machine learning model 160 may be trained on one or more of historical transaction data, Verification Unit Scores associated with historical transactions, data related to fraudulent transactions, data related to normal transactions, and other factors. The machine learning model may also be updated and re-trained based on the transaction information and the transaction score. By continually updating and re-training the machine learning model, embodiments may continually learn and adapt to various fraud techniques. In some examples, the model may be updated in real time as new data and transaction scores are analyzed, in order to provide real-time, dynamic assessments.

The machine learning model 160 may weight certain types of data and/or Verification Unit Scores differently. For example, the machine learning model 160 may weight location information, such as historical location information, over other types of transaction data information, such as a time of day of a transaction, sensor data, or other data. In other examples, the machine learning model 160 and final score 170 generation may weight certain transactions, users, demographics, data types, and other variables differently. For example, a Verification Unit Score related to Wi-Fi APS data may be weighted greater than sensor data, such as weather or altitude.

The final score 170 may be optionally returned to engine 120 for further use, such as output on an application, dashboard, or graphical user interface, or communicated to another client, service, or computing device. In some examples, the final score 170 may be returned to the engine 120 and stored in a local or remote database as historical data, training data, and/or reference data.

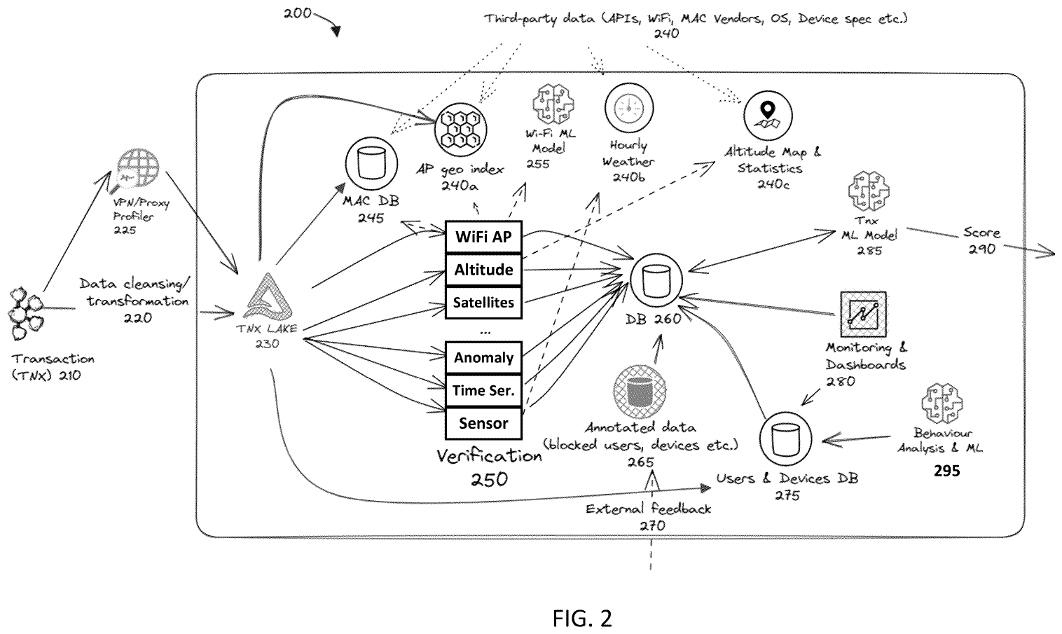

FIG. 2 illustrates an example computing architecture 200 for an anti-fraud system. A transaction 210 generates transaction data to be analyzed by the anti-fraud system. Such transactions may include purchases and/or sales related to any of a plurality of product and service businesses, such as gaming, betting, sports, and entertainment.

Transaction data may undergo data cleansing, processing, and transformation to prepare the data for ingestion into the anti-fraud system. Such data transformation may include optimizing, restructuring, and cleaning the raw data. This may result in a pipeline that can be executed through periodic jobs or structured streaming. In some examples, the transaction data may also pass through a VPN/Proxy profiler 225 for added security.

The processed data may pool in a delta lake, such as transaction lake 230 of FIG. 2, and remain until utilized in one or more processes. Such processes may relate to verification 250 and utilize one or more verification units, as discussed herein, to generate scores related to a particular characteristic of the data. Data verification methods help ensure the authenticity of incoming data and may utilize multiple techniques and methods including internal database and external APIs. In some examples, an updating mechanism ensures verification resources are up to date, and to support real-time verification of transaction data.

Data in the transaction lake 230 may also be called to one or more verification 250 processes to undergo analyses or data collection related to a characteristic of the data. Verification characteristics include, but are not limited to, information regarding Wi-Fi signals, Wi-Fi Access Points, altitude, satellites, anomalies, time series, and sensor information. Other units may analyze a device profile (e.g., installed processes, configurations, etc.) and fraud transaction fingerprinting. Fingerprinting techniques may be applied to create unique identifiers for users, transactions, user profiles, and behaviors. In some examples, transaction fingerprints may be compared to determine anomalies, behavioral trends, data integrity, data variability, and suspicious activity.

Some information in the transaction lake 230, such as Wi-Fi-related information, may also be stored in a MAC database 245, and called to one or more verification processes, such as Wi-Fi Access Points.

Third-party data 240 may provide models, indexes, and other information related to or otherwise usable with verification 250. For example, as illustrated in FIG. 2, third-party data 240 may provide information for MAC database 245, an Access Point geo index 240a, a Wi-Fi machine learning model 255, hourly weather information 240b, and altitude maps and statistics 240c. Verification units may likewise provide information to such features. For example, a verification unit related to Wi-Fi APs may provide information to AP geo index 240a and Wi-Fi model 255. Sensor information may provide relevant weather information (e.g., temperature, pressure, etc.) to the hourly weather 240b collection. The altitude verification unit may provide further data to altitude map and statistics 240c. Verification 250 results, such as verification scores, may be stored at a database 260.

Database 260 provides a fusion component for collection outputs of the verification process 250 and storing outputs in a single database. The database component may exchange data with a transaction machine learning model 285 (see, e.g., FIG. 1), where a transaction score 290 may be generated and indicative of a spoofing likelihood. Accordingly, database 260 may support queries and analyses, and provide data for machine learning model training.

In other examples, external feedback data 270 may be aggregated along with annotated data (blocked users, devices, etc.) 265 and stored at database 260. This feedback enforcement component enables the anti-fraud techniques and system to continually evolve, adapt, and improve over time. The feedback data 270 component may collect and store historical fraud data from various sources and use such data to improve the system's performance and adaptation to new attack patterns.

A users & devices database 275 may receive information from the transaction lake 230, a behavior analysis and machine learning model 285, and a monitoring & dashboard 280 component. The monitoring component may, for example, track system performance, identity issues, and provide notifications of suspicious activities. The users & devices database 275 may provide relevant information to database 260, where such information may be exchanged with the transaction machine learning model 285 and used to generate transaction score 290.

The behavior analysis and machine learning model 285 may assess a user's past behavior, such as prior transactions and associated characteristics. In other words, transaction scores and assessments may be based, at least in part, on a user's previous activity. This may include aggregating past transaction scores, analyzing used devices, and tracking location sources, among other factors. These approaches may help reduce false positive rates (i.e., incorrect fraud determinations) for users.

For example, for a transaction score based on a Wi-Fi spoofing metric, a user's previous transaction attempts and transactions scores may be considered. If past transaction scores indicate high variability with respect to Wi-Fi connection at a given location and/or on a particular device, then this factor may be taken into account for an assessment of a current transaction. An unusual or unstable Wi-Fi connection may be weighted as less indicative of a potential fraud issue than, for example, a user whose connections have been consistently steady. In the latter case, Wi-Fi variability may be more suspicious and therefore weighted differently.

In another example, the behavior analysis and machine learning model 285 may analyze short-term and long-term trends in traffic generated by different groups of users and/or different domains. By analyzing patterns in cross-operator activity, and comparing to historical trends, anomalies indicative of fraudulent activity may be better identified.

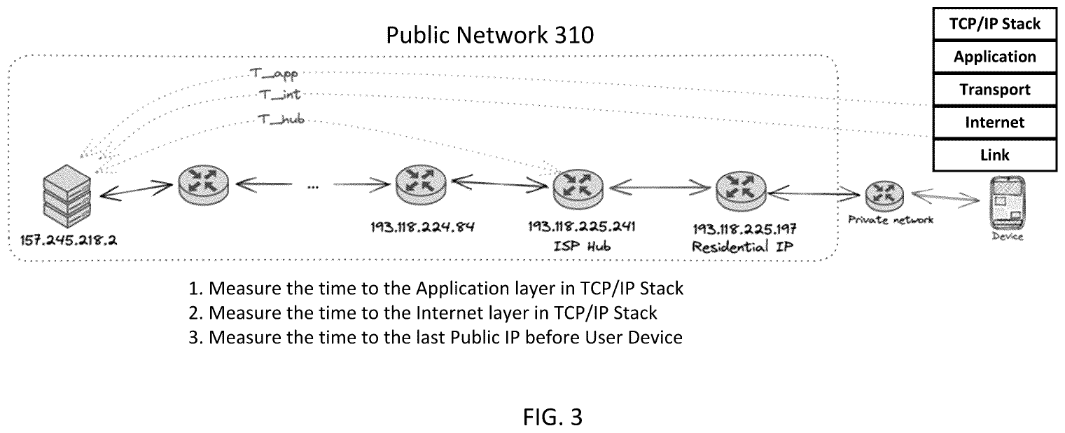

FIG. 3 provides an example diagram for Virtual Private Network (VPN)/Proxy detection, which may provide revealing information to identify fake IP addresses and attempted fraudulent transactions. Many spoofing methods rely on VPN connections or other proxy services to spoof IP addresses. A VPN/Proxy detection service may take advantage of physical limitations, structures, and protocol of a public network 310, such as the Internet, to identify instances of VPN and proxy usage. In some examples, the VPN/Proxy detection may be incorporated in or otherwise used in conjunction with a verification unit. The VPN/Proxy detection score may be incorporated into the transaction score.

A public network 310 may include a number of nodes through which information may be relayed. Time between various nodes may be measured and compared to determine a likelihood of fraudulent transactions. In the illustrated example, IP 157.245.218.2 may provide information through a plurality of nodes of the public network 310, including an ISP Hub, and a Residential IP. From the Residential IP, information gets relayed to a Private Network, to the user device. The user device provides a plurality of data layers, including a Transmission Control Protocol/Internet Protocol (TCP/IP) stack, application layer, transport layer, internet layer, and link layer.

A first time (T_app) may be measured for communication between the originating IP and the application layer in the TCP/IP stack. A second time (T_int) may be measured between the originating IP to the Internet layer in the TCP/IP stack. A third time (T_hub) may be measured between the originating IP to the last public IP before the user device. Such times may be compared, and optionally assessed with respect to previously collected data, to determine a likelihood of VPN/Proxy use.

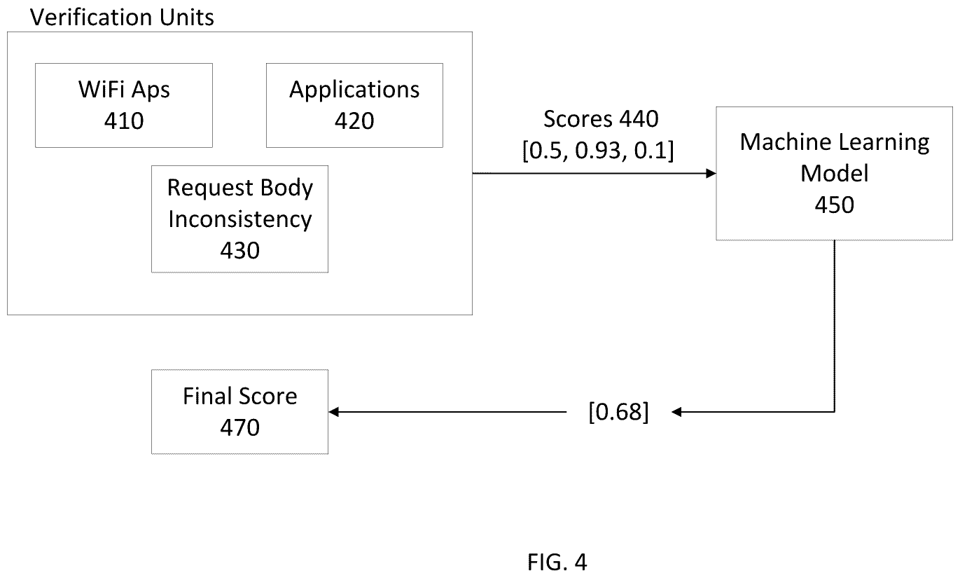

FIGS. 4-7 illustrate an example transaction score determination using crowd-sourced data, and a set of verification units. As discussed above, a verification unit may assess a characteristic of a set of transaction data to generate a spoofing metric, and a set of verification units may generate respective spoofing metrics, which are combinable to generate an overall transaction score.

In FIG. 4, the set of verification units include a Wi-Fi AP Unit 410, an Applications Unit 420, and a Request Body Inconsistency Unit 430. The Wi-Fi AP Unit 410 assesses anomaly detection for Wi-Fi access point signals. The Applications Unit 420 analyzes running applications and detects any suspicious applications. A suspicious application may be flagged as such based on its running processes, informational requests, background operations, or any of a plurality of characteristics. The Request Body Inconsistency Unit 430 detects inconsistencies and anomalies in the request body. The request body may refer to data sent from a client, such as a browser, to an API.

The verification units 410, 420, and 430 generate a set of scores 440 indicative of a spoofing metric. In the illustrated example, the Wi-Fi AP Unit 410 generates a score of 0.5, the Applications Unit 420 generates a score of 0.93, and the Request Body Inconsistency Unit 430 generates a score of 0.1. The machine learning model 450 ingests the set of scores 450 to generate an aggregated score [0.68] output as a final score 460. In some examples, scores 440 may represent normalized scores indicative of a probability of spoofing between 0.0 and 1.0. The aggregated final score 470 may be a weighted combination of sores 440, as determined by machine learning model 450.

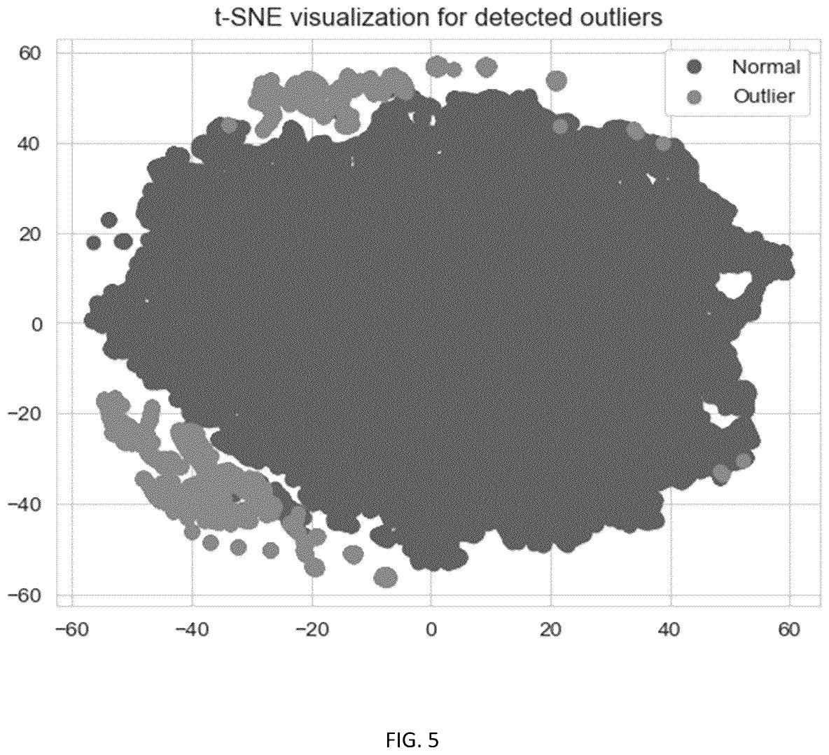

FIG. 5 illustrates an example output for a Wi-Fi Access Points Verification Unit. A Wi-Fi AP Unit may generate a t-SNE visualization for detected outliers. A t-distributed Stochastic Neighbor Embedding (t-SNE) technique is an unsupervised non-linear dimensionality reduction approach for visualizing high-dimensional data. The t-SNE output may help visualize patterns and relationships in the Wi-Fi AP data.

In an example the Wi-Fi AP Unit may assess the following Wi-Fi AP signal strength statistics: min, max, mean, median, standard deviation, 25^{th} percentile, 75^{th} percentile, precision time protocol (ptp), skewness, and kurtosis. The anomaly detect for Wi-Fi AP signal data may utilize an isolation forest model to generate a “wifi_score.”

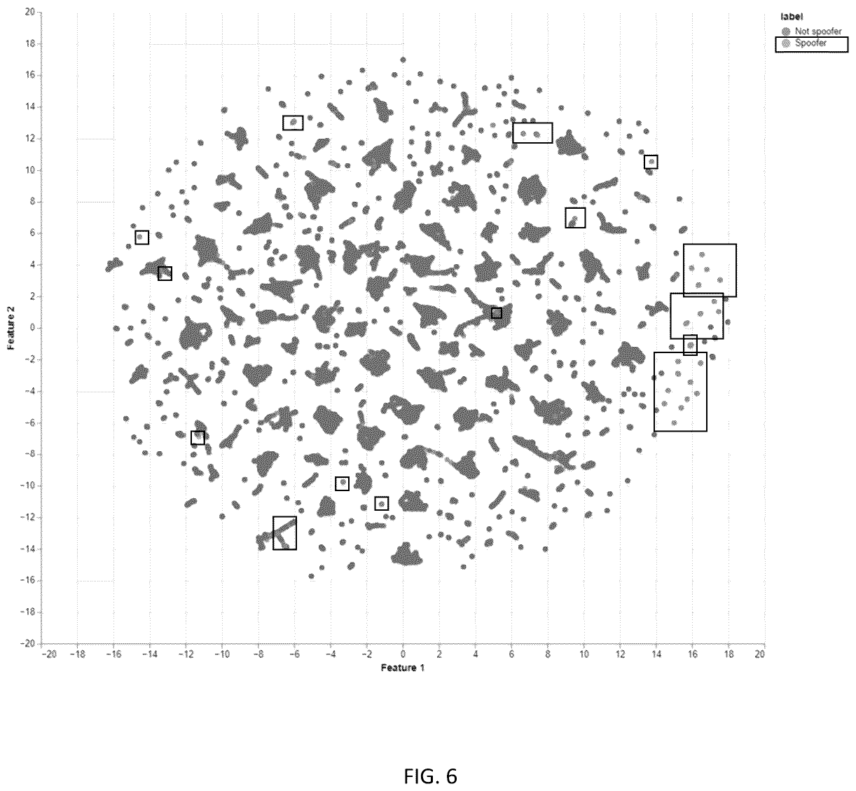

FIG. 6 illustrates an example output for an Applications Unit (e.g., Unit 420) for assessing one or more characteristics related to application(s) operating on a computing device. Visual output may indicate likely spoofed transactions (e.g., boxed points) graphed amongst identified normal transactions. In an example, the Applications Unit applies an algorithm, such as a Term Frequency-Inverse Document Frequency (TF-IDF) to generate a set of numerical features. The numerical features may relate, for example, to one or more application features and information, such as application run time, data on one or more processes, type of information requested, sent, etc. The numerical features may be fed into a classification model, such as a random forest model, to generate a process score.

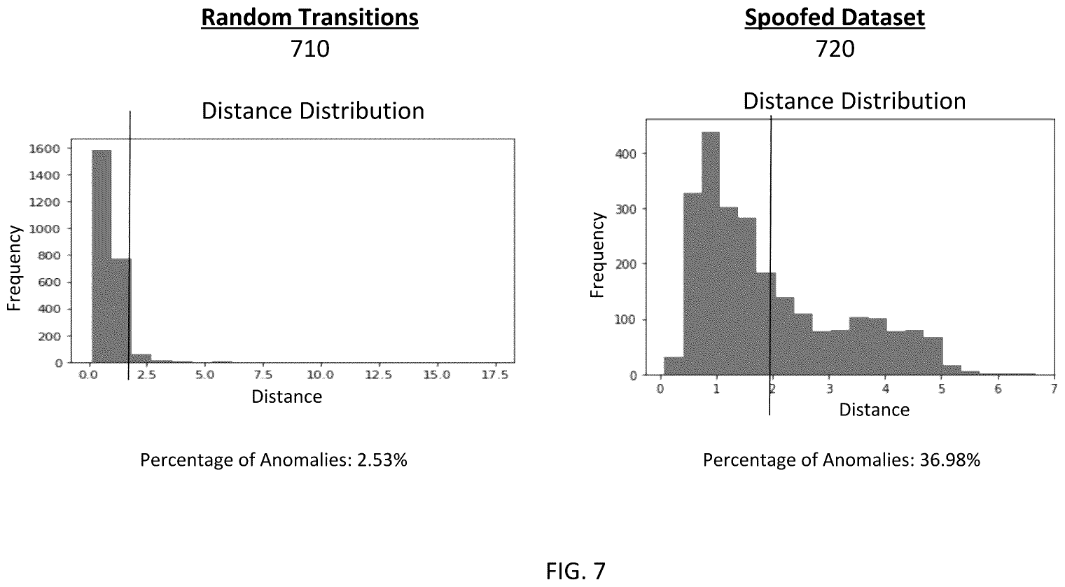

FIG. 7 illustrates an example comparative output for a Request Body Inconsistency Unit (e.g., Unit 430). In an example, K-means clustering models may group a set of data points into distinct clusters based on similarities, based on a defined parameter. Models may minimize variance within clusters and maximize variance between different clusters. The output provides a distance measure between a transaction and a center of a normal cluster, based on the defined parameter. Such distance may then generate an anomaly score to identify likely spoofed transactions.

In the random transitions output 710, the distance distribution illustrates a transaction with a relatively close measure from the center of a normal cluster. The random transitions mapping example of FIG. 7 indicates a percentage of anomalies at 2.53%. In the spoofed dataset 720, the distance measure from the center significantly increases. The percentage of anomalies is 36.98%.

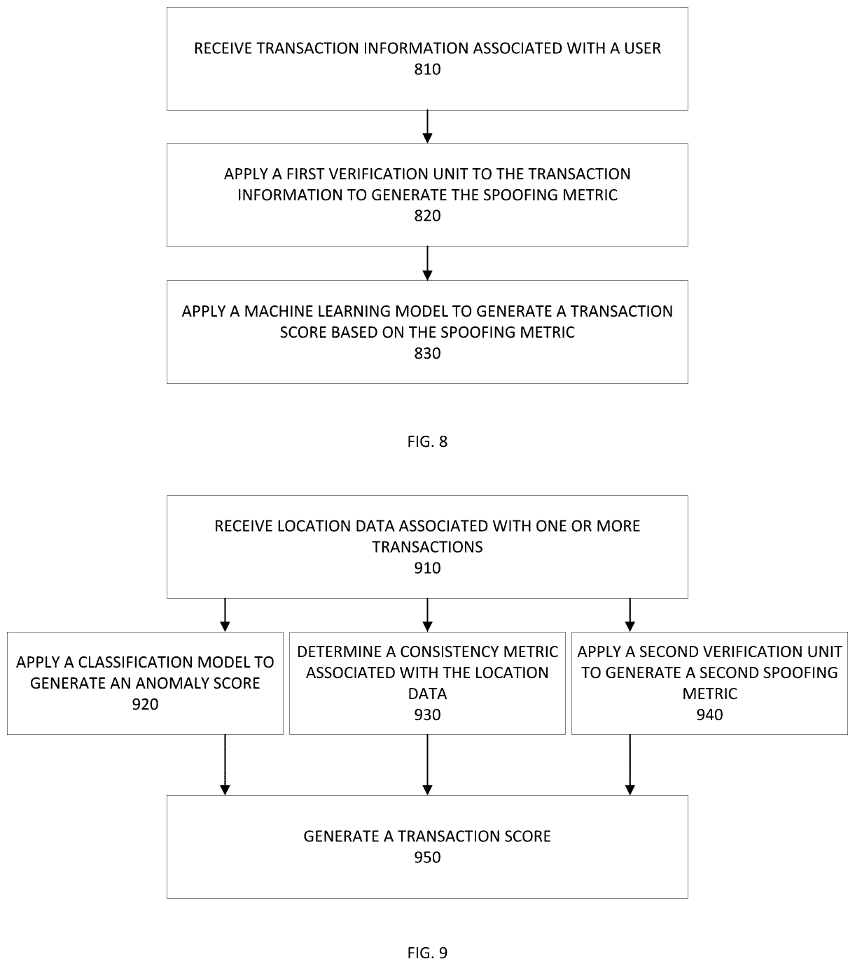

FIG. 8 illustrates a flowchart for anti-fraud determinations. At block 810, aspects may receive transaction information associated with a user. Transaction data may relate to gaming, betting, purchases, sales, or other financial, commercial, remote, and/or online transactions associated with a user. Transaction data may be received and processed in real time, and include information about a time, date, location, size, or amount of the transaction, as well as information about one or more devices, networks, servers, databases, or other nodes and connections handling data and communications.

At block 820, aspects may apply a first verification unit to the transaction information to generate the spoofing metric. The first verification unit may analyze a specific characteristic related to historical location data. Some examples include Wi-Fi data, Wi-Fi Access Point Signal data, application data, sensor data, atmospheric pressure data, altitude data, satellite data, fingerprinting data, and fraudulent transaction data, among others.

Generally, characteristics should be identifiable from historical transaction data so that comparisons may be made to the transaction data associated with the user. As such, transaction data may be compared to crowd-sourced data, and a spoofing metric determined with respect to the characteristic. In some examples, location-based checks include cross-checking transactions that originate from a same location. The location may be a region, such as a state, building, home, or other area where transactions commonly occur. The location-based cross-checks collect and assess data associated with a plurality of devices within a particular region. Such information is therefore useful to assess many characteristics, such as those related to Wi-Fi Access Points, atmospheric pressure data, and altitude data, among others.

The spoofing metric represents a likelihood of a fraudulent or spoofed transaction. The spoofing metric may be associated with at least one of: a process score, an anomaly detection, a Wi-Fi score, information regarding a prior transaction block, one or more historical transactions, a suspicion measurement, and a detection score.

Multiple verification units may analyze the transaction data, targeting different characteristics to generate multiple spoofing metrics. For example, a first verification unit may generate a first spoofing metric based on Wi-Fi Access Point Signal data associated with the crowd-sourced collection of historical location data. The first verification unit may compare the current transaction information with the crowd-sourced historical data to generate a first spoofing metric corresponding to Wi-Fi Access Point Signal data. A second verification unit may generate a second spoofing metric based on a fraudulent transaction associated with the historical location data. It may be the case that the historical location data signifies that a set of known fraudulent transactions occurred within a specific location or region. The second verification unit may take that characteristic, compare it to the received transaction information, and determine the second spoofing metric to indicate how likely the received transaction may be fraudulent based on its location.

In various embodiments, verification units may generate a spoofing metric using any of a plurality of methods and techniques, including, but not limited to, generating a set of numerical features from the location data, applying a classification model, and generating an anomaly score.

In some examples, the verification units may utilize one or more machine learning models to assess the transaction data and generate the spoofing metric. For example, the first verification unit may apply a machine learning model to assist with pattern recognition using crowd-sourced historical transaction data and compare current transaction data to the historical patterns to identify any anomalies or outliers.

Some aspects may apply a second verification unit to generate a second spoofing metric. The second verification unit may analyze a different set of transaction data characteristics than the first verification unit. For example, a first verification unit may analyze Wi-Fi data associated with the current transaction and compare to Wi-Fi data associated with similar historical transactions. Similar historical transactions may, for example, be transactions associated with one or more of: a same user, a same device or set of devices associated with the user (e.g., cell phone, tablet, laptop, gaming station, home computer, etc.), a similar type of transaction (e.g., sports betting, remote/online transactions, gaming, etc.), crowd-sourced data collected from a plurality of users, crowd-sourced transactions associated with a particular geographical area (e.g., a state, casino, sports bar, etc.), and a particular player demographic.

At block 830, aspects may apply a machine learning model to generate a transaction score based on the spoofing method. The transaction score is indicative of a fraudulent transaction and may provide an overall assessment or likelihood of whether or not the current transaction is spoofed or other otherwise fraudulent. The transaction-score machine learning model may be trained on historical transaction data, specifically crowd-sourced, historical location data. For example, the historical location data may be associated with nearby transactions within a location range.

In some examples, the transaction score model may receive a plurality of spoofing metrics respectively generated from a plurality of verification units, analyze crowd-sourced historical location data, compare the current transaction to the historical location data, and generate the transaction score.

In some examples, the machine learning model associated with the transaction score is different than any machine learning models applied by the first verification unit to generate the spoofing metric. For example, a first machine learning model may be applied by the verification unit to assess a characteristic associated with the verification unit (e.g., location data, sensor data, Wi-Fi data, etc.). The verification unit may generate a spoofing metric associated with the characteristic (e.g., Wi-Fi data). The transaction score model may receive the spoofing metric associated with the characteristic, assess the spoofing metric and current transaction data in view of crowd-sourced historical location data to generate the transaction score and help determine whether the current transaction is fraudulent. Put another way, the transaction score model may analyze the spoofing metric, in view of previous transactions to determine an overall authenticity (i.e., fraud prediction) of the transaction.

In various embodiments, the machine learning model may be updated in real time, based on the transaction information and the transaction score.

According to some embodiments, the transaction score may be provided on a dashboard displayed on a graphical user interface. The dashboard may be configured to perform at least one of: performance monitoring, issue identification, and notifications regarding suspicious activity. Performance monitoring may relate to a status related to one or more fraud detection steps discussed herein. An issue identification may occur when an error arises during the fraud-detection process and/or more information is needed. For example, an issue with a verification unit may trigger an issue-identification notification. Notifications regarding suspicious activity may occur, for example, when a spoofing metric and/or transaction score reaches a threshold. The threshold may be indicative of fraudulent activity being more likely than not. However, any of a plurality of suspicious activity triggers and thresholds may be defined, adjusted, and otherwise customized based on preference and needs of the particular anti-fraud system and application.

Notifications may also be provided to one or more local or remote computing devices, and may include one or more of a visual, auditory, and haptic feedback. Notifications may, for example, indicate that a particular device or user may be attempting a spoofed or fraudulent transactions. Notifications may also indicate a potential issue or flag regarding one or more transactions. Notifications may be customized based on particular events, triggers, thresholds, times, and any of a plurality of instances.

FIG. 9 illustrates a flow chart detailing techniques for generating a transaction score. At block 910, aspects may receive location data associated with one or more transactions. As discussed herein, the location data may be crowd-sourced historical location data as well as a current transaction for analysis.

At block 920, aspects may apply a classification model to generate an anomaly score. In various examples, the anomaly score is a type of spoofing metric. The classification model may analyze any of a plurality of features, such as the characteristics discussed above, at least with respect to FIG. 8. The classification model can analyze normal and anomalous instances with respect to the historical transaction data and a particular characteristic. For a given transaction, an anomaly score may be generated based on the classification model, and a comparison made between the given transaction to a set of one or more transactions. The anomaly score may be indicative of the given transaction being spoofed or fraudulent with respect to the analyzed characteristic. The anomaly score may then influence the transaction score generation 950.

At block 930, aspects may determine a consistency metric associated with the location data. For example, a plurality of known, valid (i.e., non-spoofed) transactions that regularly occur at a particular location may provide a consistency metric indicative of a low likelihood of fraudulent activity. Various factors may impact the consistency metric; for example, a same device or user performing the valid transactions may provide increased confidence for the consistency metric. On the other hand, transaction information coming from a location outside of a typical transaction or gaming region may lower the consistency metric, and that may be an indication that an unauthorized, user device, or attempt is being made. While the consistency metric itself may not necessarily be a definitive assessment of fraud or spoofing, the consistency metric, like the anomaly score, may contribute to the overall transaction score generation 950.

At block 940, aspects may apply a second verification unit to generate a second spoofing metric. As discussed herein, the second verification may target a second characteristic associated with the crowd-sourced historical data. The second characteristic may relate to a location attribute and provide a comparison between current transaction data and the historical data. The second spoofing metric may also contribute to the overall transaction score 950.

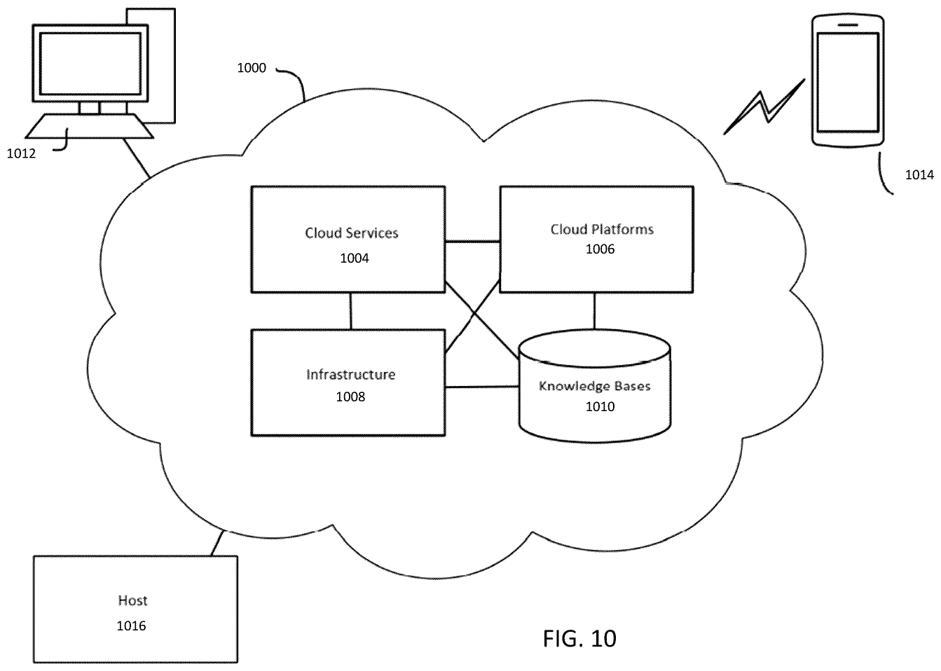

FIG. 10 shows example components of a cloud computing system 1000. By way of example and without limitation, cloud computing system 1000 may be used to perform aspects of the disclosed subject matter. Cloud-based computing generally refers to networked computer architectures where application execution, service provision, and data storage may be divided, to some extent, between clients and cloud computing devices. The “cloud” may refer to a service or a group of services accessible over a network, for example, the Internet, by clients, server devices, and by other cloud computing systems.

In one example, multiple computing devices connected to the cloud may access and use a common pool of computing power, services, applications, storage, and files. Thus, cloud computing enables a shared pool of configurable computing resources, e.g., networks, servers, storage, applications, and services, which may be provisioned and released with minimal management effort or interaction by the cloud service provider.

As an example, a cloud-based application may store copies of data and/or executable program code in the cloud computing system, while allowing client devices to download at least some of this data and program code as needed for execution at the client devices. In some examples, downloaded data and program code may be tailored to the capabilities of specific client devices, e.g., a personal computer, tablet computer, mobile phone, and/or smartphone, accessing the cloud-based application. Additionally, dividing application execution and storage between client devices and the cloud computing system allows more processing to be performed by the cloud computing system, thereby taking advantage of the cloud computing system's processing power and capability.

Cloud-based computing can also refer to distributed computing architectures where data and program code for cloud-based applications are shared between one or more client devices and/or cloud computing devices on a near real-time basis. Portions of this data and program code may be dynamically delivered, as needed or otherwise, to various clients accessing the cloud-based application. Details of the cloud-based computing architecture may be largely transparent to users of client devices. By way of example and without limitation, a PC user device accessing a cloud-based application may not be aware that the PC downloads program logic and/or data from the cloud computing system, or that the PC offloads processing or storage functions to the cloud computing system, for example.

In FIG. 10, cloud computing system 1000 includes one or more cloud services 104, one or more cloud platforms 1006, cloud infrastructure components 1008, and cloud knowledge bases 1010. Cloud computing system 1000 may include more of fewer components, and each of cloud services 1004, cloud platforms 1006, cloud infrastructure components 108, and cloud knowledge bases 1010 may include multiple computing and storage elements as well. Thus, one or more of the described functions of cloud computing system 1000 may be divided into additional functional or physical components, or combined into fewer functional or physical components. In some further examples, additional functional and/or physical components may be added to the examples shown in FIG. 10. Delivery of cloud computing-based services may involve multiple cloud components communicating with each other over application programming interfaces, such as web services and multi-tier architectures.

Example cloud computing system 1000 shown in FIG. 10 is a networked computing architecture. Cloud services 1004 may represent queues for handling requests from client devices. Cloud platforms 1006 may include client-interface frontends for cloud computing system 1000, such as client-interface frontends of a messaging service. Cloud platforms 1006 may be coupled to cloud services 1004 to perform functions for interacting with client devices. Cloud infrastructure 108 may include service, billing, and other operational and infrastructure components of cloud computing system 1000. Cloud knowledge bases 1010 are configured to store data for use by cloud computing system 1000, and thus, cloud knowledge bases 1010 may be accessed by any of cloud services 1004, cloud platforms 1006, and/or cloud infrastructure components 1008.

Many different types of client devices, such as devices of users of the messaging service, may be configured to communicate with components of cloud computing system 1000 for the purpose of accessing data and executing applications provided by cloud computing system 1000. For example, a computer 1012, a mobile device 1014, and a host 1016 are shown as examples of the types of client devices that may be configured to communicate with cloud computing system 1000. Of course, more or fewer client devices may communicate with cloud computing system 1000. In addition, other types of client devices may also be configured to communicate with cloud computing system 1000 as well.

Computer 1012 shown in FIG. 10 may be any type of computing device, e.g., PC, laptop computer, tablet computer, etc., and mobile device 1014 may be any type of mobile computing device, e.g., laptop, smartphone, mobile telephone, cellular telephone, tablet computer, etc., configured to transmit and/or receive data to and/or from cloud computing system 100. Similarly, host 1016 may be any type of computing device with a transmitter/receiver including a laptop computer, a mobile telephone, a smartphone, a tablet computer, etc., which is configured to transmit/receive data to/from cloud computing system 1000.

In FIG. 10, communication links between client devices and cloud 1000 may include wired connections, such as a serial or parallel bus, Ethernet, optical connections, or other type of wired connection. Communication links may also be wireless links, such as Bluetooth, IEEE 802.11 (IEEE 802.11 may refer to IEEE 802.11-2007, IEEE 802.11n-2009, or any other IEEE 802.11 revision), CDMA, 3G, GSM, WiMAX, or other wireless-based data communication links.

In other examples, the client devices may be configured to communicate with cloud computing system 100 via wireless access points. Access points may take various forms. For example, an access point may take the form of a wireless access point (WAP) or wireless router. As another example, if a client device connects using a cellular air-interface protocol, such as CDMA, GSM, 3G, or 4G, an access point may be a base station in a cellular network that provides Internet connectivity via the cellular network.

As such, the client devices may include a wired or wireless network interface through which the client devices may connect to cloud computing system 1000 directly or via access points. As an example, the client devices may be configured to use one or more protocols such as 802.11, 802.16 (WiMAX), LTE, GSM, GPRS, CDMA, EV-DO, and/or HSPDA, among others. Furthermore, the client devices may be configured to use multiple wired and/or wireless protocols, such as “3G” or “4G” data connectivity using a cellular communication protocol, e.g., CDMA, GSM, or WiMAX, as well as for “Wi-Fi” connectivity using 802.11. Other types of communications interfaces and protocols could be used as well.

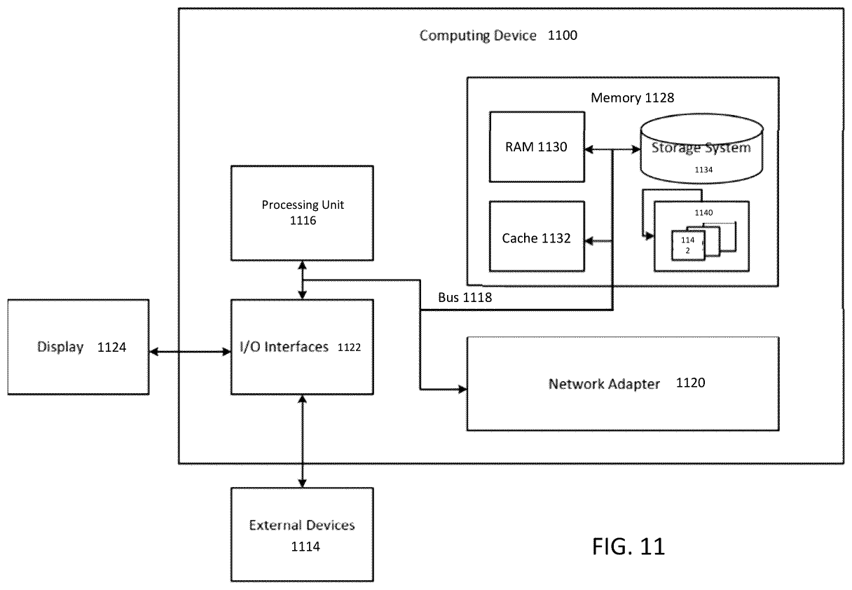

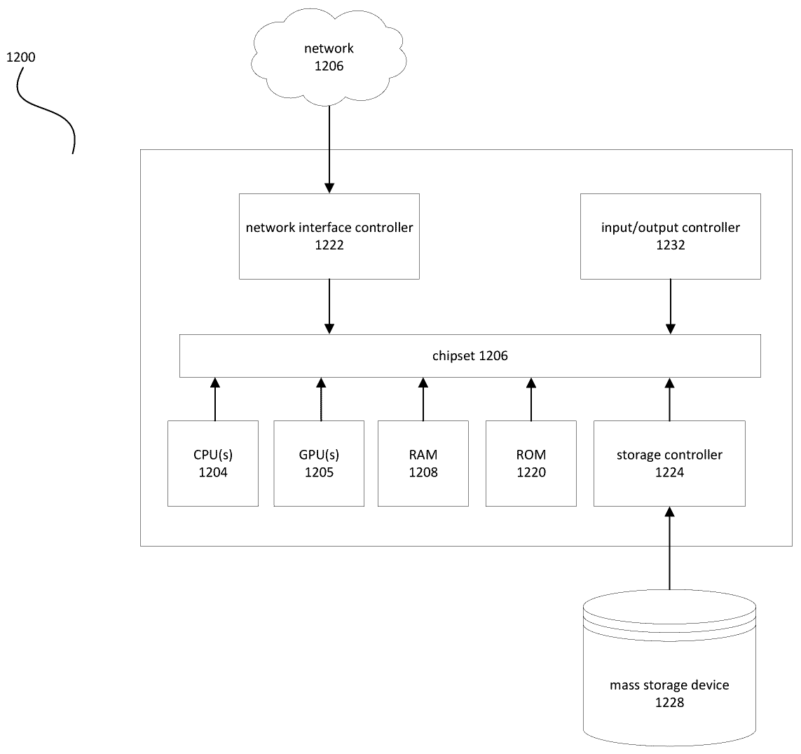

FIG. 11 shows such a general-purpose computing device 1100. The computing device 1100 may operate in a virtual environment, such as the environment 1000 in FIG. 10. Computing device 1100 may be used to host the messaging service or the messaging application. Computing device 1100 may be configured to communicate with devices of users of the messaging application. Computing device 1100 may be a general-purpose computing device. Computing device 1100 may be an on-premises device, such as a node of a distributed system running in a user's data center. The components of computing device 1100 may include, but are not limited to, one or more processors or processing units 1116, a system memory 1128, and a bus 1118 that couples various system components including system memory 1128 to processor 1116.

The bus 1118 in the example of FIG. 11 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (“ISA”) bus, Micro Channel Architecture (“MCA”) bus, Enhanced ISA (“EISA”) bus, Video Electronics Standards Association (“VESA”) local bus, and Peripheral Component Interconnects (“PCI”) bus.

Computing device 1100 may include a variety of computer system readable media. Such media may be any available media that is accessible by computing device 1100, and it includes both volatile and non-volatile media, and removable and non-removable media. Computing device 1100 may include system memory 1128, which may include computer-system-readable media in the form of volatile memory, such as random-access memory (“RAM”) 1130 and/or cache memory 1132. Computing device 1100 may further include other removable/non-removable, volatile/non-volatile computer system storage media. By way of example only, a storage system 1134 may be provided for reading from and writing to a non-removable, non-volatile magnetic media (not shown and typically called a “hard drive”). Although not shown, a magnetic disk drive for reading from and writing to a removable, non-volatile magnetic disk, e.g., a “floppy disk,” and an optical disk drive for reading from or writing to a removable, non-volatile optical disk such as a CD-ROM, DVD-ROM, or other optical media may be provided. In such instances, each may be connected to bus 1118 by one or more data media interfaces. As will be further depicted and described below, memory 1128 may include at least one program product having a set, i.e., at least one, of program modules that are configured to carry out the functions of embodiments of the invention.

Computing device 1100 may include a program/utility 1140 having a set (at least one) of program modules 1142 that may be stored in memory 1128. Computing device 1100 of FIG. 11 may also include an operating system, one or more messaging application programs, other messaging application program modules, and messaging application program data. Each of the operating system, one or more messaging application programs, other messaging application program modules, messaging application program data, or some combination thereof, may include an implementation of a networking environment, such as the cloud computing system 100 in FIG. 1. Program modules 1142 generally carry out the functions and/or methodologies of embodiments of the invention as described herein.

Computing device 1100 of FIG. 11 may also communicate with one or more external devices 1114 such as a keyboard, a pointing device, a display 1124, and so on that enable a user to interact with computing device 1100. Computing device 1100 may also include any devices, e.g., network card, modem, etc., that enable computing device 1100 to communicate with one or more other computing devices. Such communication may occur, for example, via I/O interfaces 1121. Still yet, computing device 1100 may communicate with one or more networks, such as a local area network (“LAN”), a general wide area network (“WAN”), and/or a public network, e.g., the Internet, via network adapter 1120. As depicted, network adapter 1120 communicates with the other components of computing device 1100 via bus 1118. It should be understood that, although not shown, other hardware and/or software components could be used in conjunction with computing device 1100. Examples include, but are not limited to, microcode, device drivers, redundant processing units, external disk drive arrays, RAID systems, tape drives, and data archival storage systems, and so on.

FIG. 12 depicts an example computing device 1200 that may represent any of the various devices or entities illustrated in FIG. 1-11, including, for example, the devices 1012, 1014, 1016, 1100, servers/routers, etc. That is, the computing device 1200 shown in FIG. 12 may be any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the methods described above with respect to FIGS. 1-11.

The computing device 1200 may include a baseboard, or “motherboard,” which is a printed circuit board to which a multitude of components or devices may be connected by way of a system bus or other electrical communication paths. One or more central processing units (CPUs or “processors”) 1204 may operate in conjunction with a chipset 1206. The CPU(s) 1204 may be standard programmable processors that perform arithmetic and logical operations necessary for the operation of the computing device 1200.

The CPU(s) 1204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1204 may be augmented with or replaced by other processing units, such as GPU(s) 1205. The GPU(s) 1205 may comprise processing units specialized for but not necessarily limited to highly parallel computations, such as graphics and other visualization-related processing.

A chipset 1206 may provide an interface between the CPU(s) 1204 and the remainder of the components and devices on the baseboard. The chipset 1206 may provide an interface to a random-access memory (RAM) 1208 used as the main memory in the computing device 1200. The chipset 1206 may provide an interface to a computer-readable storage medium, such as a read-only memory (ROM) 1220 or non-volatile RAM (NVRAM) (not shown), for storing basic routines that may help to start up the computing device 1200 and to transfer information between the various components and devices. ROM 1220 or NVRAM may also store other software components necessary for the operation of the computing device 1200 in accordance with the aspects described herein.

The computing device 1200 may operate in a networked environment using logical connections to remote computing nodes and computer systems of the platform 100. The chipset 1206 may include functionality for providing network connectivity through a network interface controller (“NIC”) 1222. A NIC 1222 may be capable of connecting the computing device 1200 to other computing nodes over the platform 100. It should be appreciated that multiple NICs 1222 may be present in the computing device 1200, connecting the computing device to other types of networks (e.g., network 1202) and remote computer systems. The NIC may be configured to implement a wired local area network technology, such as IEEE 802.3 (“Ethernet”) or the like. The NIC may also comprise any suitable wireless network interface controller capable of wirelessly connecting and communicating with other devices or computing nodes on the platform 100. For example, the NIC 1222 may operate in accordance with any of a variety of wireless communication protocols, including, for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 1200 may be connected to a mass storage device 1228 that provides non-volatile storage (i.e., memory) for the computer. The mass storage device 1228 may store system programs, application programs, other program modules, and data, which have been described in greater detail herein. The mass storage device 1228 may be connected to the computing device 1200 through a storage controller 1224 connected to the chipset 1206. The mass storage device 1228 may consist of one or more physical storage units. A storage controller 1224 may interface with the physical storage units through a Serial Attached SCSI (SAS) interface, a Serial Advanced Technology Attachment (SATA) interface, a Fibre Channel (FC) interface, or other type of interface for physically connecting and transferring data between computers and physical storage units.

The computing device 1200 may store data on a mass storage device 1228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1228 is characterized as primary or secondary storage and the like.

For example, the computing device 1200 may store information to the mass storage device 1228 by issuing instructions through a storage controller 1224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1200 may read information from the mass storage device 1228 by detecting the physical states or characteristics of one or more particular locations within the physical storage units.

In addition to the mass storage device 1228 described herein, the computing device 1200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1200.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 1228 depicted in FIG. 12, may store an operating system utilized to control the operation of the computing device 1200. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 1228 may store other system or application programs and data utilized by the computing device 1200.

The mass storage device 1228 or other computer-readable storage media may also be encoded with computer-executable instructions, which, when loaded into the computing device 1200, transforms the computing device from a general-purpose computing system into a special-purpose computer capable of implementing the aspects described herein. These computer-executable instructions transform the computing device 1200 by specifying how the CPU(s) 1204 transition between states, as described herein.

A computing device, such as the computing device 1200 depicted in FIG. 12, may also include an input/output controller 1232 for receiving and processing input from a number of input devices, such as a keyboard, a mouse, a touchpad, a touch screen, an electronic stylus, or other type of input device. Similarly, an input/output controller 1232 may provide output to a display, such as a computer monitor, a flat-panel display, a digital projector, a printer, a plotter, or other type of output device. It will be appreciated that the computing device 1200 may not include all of the components shown in FIG. 12, may include other components that are not explicitly shown in FIG. 12, or may utilize an architecture completely different than that shown in FIG. 12.

As described herein, a computing device may be a physical computing device, such as the computing device 1200 of FIG. 12. A computing device may also include a virtual machine host process and one or more virtual machine instances. Computer-executable instructions may be executed by the physical hardware of a computing device indirectly through interpretation and/or execution of instructions stored and executed in the context of a virtual machine.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

It will also be appreciated that various items are illustrated as being stored in memory or storage while being used, and that these items or portions of thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems, and data structures may also be stored (e.g., as software instructions or structured data) on a computer-readable medium, such as a hard disk, memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements, and modifications of the concepts described herein are possible without departing from the underlying principles of the invention. The scope of the invention should therefore be determined only by the following claims and their equivalents.

The above-described aspects of the disclosure have been described with regard to certain examples and embodiments, which are intended to illustrate but not to limit the disclosure. It should be appreciated that the subject matter presented herein may be implemented as a computer process, a computer-controlled apparatus, a computing system, or an article of manufacture, such as a computer-readable storage medium.

Those skilled in the art will also appreciate that the subject matter described herein may be practiced on or in conjunction with other computer system configurations beyond those described herein, including multiprocessor systems, microprocessor-based or programmable consumer electronics, minicomputers, mainframe computers, handheld computers, personal digital assistants, e-readers, cellular telephone devices, biometric devices, mobile computing devices, special-purposed hardware devices, network appliances, and the like. The embodiments described herein may also be practiced in distributed computing environments, where tasks are performed by remote processing devices that are linked through a communications network. In a distributed computing environment, program modules may be located in both local and remote memory storage devices.

A number of different types of computing devices may be used singly or in combination to implement the resources and services in different embodiments, including general-purpose or special-purpose computer servers, storage devices, network devices, and the like. In at least some embodiments, a server or computing device may implement at least a portion of one or more of the technologies described herein, including the techniques to implement the functionality of aspects discussed herein.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

In an embodiment, a fraud-detection system comprises a database comprising historical location data associated with one or more transactions; a first verification unit generating a spoofing metric based on a characteristic of the historical location data; at least one processor; and a memory comprising instructions, which when executed by the processor, cause the system to: receive transaction information associated with a user; apply the first verification unit to the transaction information to generate the spoofing metric; and generate a transaction score based on the spoofing metric, wherein the transaction score is indicative of a fraudulent transaction prediction.

In an embodiment, wherein the characteristic is at least one of IP data, Wi-Fi data, Wi-Fi Access Point Signal data, application data, sensor data, atmospheric pressure data, altitude data, satellite data, fingerprinting data, and fraudulent transaction data.

In an embodiment, the system of claim 1, wherein the spoofing metric is indicative of at least one of: an anomaly detection, a Wi-Fi score, a suspicion measurement, and a detection score.

In an embodiment, further comprising: a second verification unit generating a second spoofing metric based on a second characteristic of the historical location data.

In an embodiment, further comprising: a dashboard provided on a display, wherein the dashboard provides information relating to at least one of: performance monitoring; issue identification; and suspicious activity notification.

In an embodiment, wherein the historical location data comprises crowd-sourced transaction data from a plurality of users.

In an embodiment, wherein generating the transaction score comprises applying a machine learning model trained on the historical location data associated with one or more prior transactions and associated fraud determinations.

In an embodiment, further comprising updating the machine learning model based on the transaction information and the transaction score.

In an embodiment, wherein the historical location data corresponds to a collection of prior transactions associated with the user.

In an embodiment, wherein the database is updated with new historical location data, in real time.

In an embodiment, wherein the first verification unit generates the spoofing metric by at least: generating a set of numerical features from the historical location data, wherein the set of numerical features is associated with the characteristic; applying a classification model to sort the numerical features; and comparing respective attributes of the transaction information to generate the spoofing metric.

In an embodiment, a method to detect fraudulent activity for a remote transaction, comprises: receiving transaction information associated with a user; generating a spoofing metric based on a comparison between the transaction information and crowd-sourced historical location data associated with one or more previous transactions; and generating a transaction score based on the spoofing metric, wherein the transaction score is indicative of a fraudulent transaction prediction.

In an embodiment, wherein the spoofing metric is further based on a cross-check of historical transactions originating from a same location as the transaction information.

In an embodiment, further comprising: storing location data from a user device in a database comprising historical location data associated with one or more transactions; and verifying, in real time, a consistency of the location data.

In an embodiment, wherein generating the transaction score comprises applying a machine learning model to analyze the spoofing metric and the transaction information, wherein the machine learning model is trained on crowd-sourced historical location data associated with prior transactions.

In an embodiment, further comprising: re-training the machine learning model based on the transaction information and the transaction score.

In an embodiment, wherein the crowd-sourced historical location data comprises nearby transactions within a location range.

In an embodiment, wherein the comparison analyzes at least one of IP data, Wi-Fi data, Wi-Fi Access Point Signal data, application data, sensor data, atmospheric pressure data, altitude data, satellite data, fingerprinting data, and fraudulent transaction data.

In an embodiment, a non-transitory computer-readable storage medium comprising instructions stored thereon, which when executed by a processor, cause a computing system to at least: receive transaction information; apply a first verification unit to the transaction information, wherein the first verification unit generates a spoofing metric based on a comparison between the transaction information and crowd-sourced historical location data associated with one or more transactions; and apply a machine learning model to generate a transaction score based on the spoofing metric, wherein the machine learning model is trained on the crowd-sourced historical location, and wherein the transaction score is indicative of a fraudulent transaction prediction.

In an embodiment, wherein the comparison analyzes at least one of IP data, Wi-Fi data, Wi-Fi Access Point Signal data, application data, sensor data, atmospheric pressure data, altitude data, satellite data, fingerprinting data, and fraudulent transaction data.

1. A fraud detection system, comprising:
a database comprising historical location data associated with one or more transactions, the database receiving dynamic updates from at least one external source, the dynamic updates comprising information associated with a plurality of transaction characteristics associated with the one or more transactions;
at least one processor and a memory comprising instructions, which when executed by the processor, cause the system to:
establish a remote connection with an application program interface operating on a user device;
send, by the application programming interface, a raw data stream indicative of a transaction initiated via one or more user operations entered via the user device;
transform the raw data stream to a format for storage in a transaction lake, wherein the format enables accessibility by at least one verification process calling the transaction lake;
generate a device fingerprint and a set of transaction characteristics associated with the transformed data in the transaction lake, wherein the set of transaction characteristics comprises one or more of the plurality of transaction characteristics;
in response to generating the device fingerprint, establish a remote connection with the database to acquire and store, in the transaction lake, at least Wi-Fi Access Point Signal information for the user device associated with the transaction information; and
execute a verification process that calls the transaction lake to acquire data for assessing a transaction characteristic from the set of transaction characteristics, wherein the verification process comprises:
generating a set of verification scores, each verification score being indicative of a spoofing metric associated with the transaction characteristic, wherein a first verification score is determined using a first machine learning model determining location anomalies based on the Wi-Fi Access Point Signal information and the transaction information;
applying a second machine learning model trained to analyze the set of verification scores, to generate a transaction score indicative of a fraudulent transaction prediction;
re-training the first machine learning model with the transaction score and the dynamic updates; and
re-training the second machine learning model with the transaction score and the transaction information.

2. The system of claim 1, wherein the transaction characteristic is at least one of IP data, Wi-Fi data, Wi-Fi Access Point Signal data, application data, sensor data, atmospheric pressure data, altitude data, satellite data, fingerprinting data, and fraudulent transaction data.

3. The system of claim 1, wherein the spoofing metric is indicative of at least one of: an anomaly detection, a Wi-Fi score, a suspicion measurement, and a detection score.

4. The system of claim 1, wherein the memory further comprises instructions that cause the system to generate a second verification score indicative of a second spoofing metric, wherein the second spoofing metric is based on a second transaction characteristic of the historical location data.

5. The system of claim 1, further comprising: a dashboard provided on a display, wherein the dashboard provides information relating to at least one of: performance monitoring, issue identification, and suspicious activity notification.

6. The system of claim 1, wherein the historical location data comprises crowd-sourced transaction data from a plurality of users.

7. The system of claim 1, further comprising training the second machine learning model on the historical location data associated with one or more prior transactions and associated fraud determinations.

8. The system of claim 1, further comprising updating the second machine learning model, in real time, based on the transaction information and the transaction score.

9. The system of claim 7, wherein the historical location data corresponds to a collection of prior transactions associated with the user.

10. The system of claim 1, wherein the database is updated with new historical location data, in real time.

11. The system of claim 1, wherein the first machine learning model generates the spoofing metric by at least:
generating a set of numerical features from the historical location data, wherein the set of numerical features is associated with the transaction characteristic;
applying a classification model to sort the numerical features; and
comparing respective attributes of the transaction information to generate the spoofing metric.

12. A method to detect fraudulent activity for a remote transaction, comprising:
storing, at a database, historical location data associated with one or more transactions;
dynamically updating the database with Wi-Fi Access Point Signal information and information from at least one external source, wherein the information is associated with a plurality of transaction characteristics associated with the one or more transactions;
establishing a remote connection with an application program interface operating on a user device;
sending, by the application programming interface, a raw data stream indicative of a transaction initiated via one or more user operations entered via the user device;
transforming the raw data stream to a format for storage in a transaction lake, wherein the format enables accessibility by at least one verification process calling the transaction lake;
generating a device fingerprint and a set of transaction characteristics associated with the transformed data in the transaction lake, wherein the set of transaction characteristics comprises one or more of the plurality of transaction characteristics;
in response to generating the device fingerprint, establishing a remote connection with the database to acquire Wi-Fi Access Point Signal information for the user device associated with the transaction information; and
executing a verification process that calls the transaction lake to acquire data for assessing a transaction characteristic from the set of transaction characteristics, wherein the verification process comprises:
generating a set of verification scores, each verification score being indicative of a spoofing metric associated with the transaction characteristic, wherein a first verification score is determined using a first machine learning model determining location anomalies based on the Wi-Fi Access Point Signal information and the transaction information;
applying a second machine learning model trained to analyze the set of verification scores, to generate a transaction score indicative of a fraudulent transaction prediction;
re-training the first machine learning model based on the transaction score and the information from the at least one external source; and
re-training the second machine learning model using the transaction score and the transaction information.

13. The method of claim 12, wherein the spoofing metric is further based on a cross-check of historical transactions originating within a range of a location associated with the transaction information.

14. The method of claim 12, further comprising:
storing location data from the user device in the database comprising historical location data associated with one or more transactions; and
verifying, in real time, a consistency of the location data.

15. The method of claim 12, wherein the second machine learning model is trained on crowd-sourced historical location data associated with prior transactions.

16. The method of claim 12, further comprising: dynamically updating the database with behavioral information associated with the one or more transactions, wherein the behavioral information is determined by a third machine learning model trained to analyze transaction scores and the transaction information.

17. The method of claim 12, wherein the historical location data comprises transactions within a distance of a location associated with the transaction information.

18. The method of claim 12, wherein the transaction characteristic is at least one of IP data, Wi-Fi data, Wi-Fi Access Point Signal data, application data, sensor data, atmospheric pressure data, altitude data, satellite data, fingerprinting data, and fraudulent transaction data.

19. A non-transitory computer-readable storage medium comprising instructions stored thereon, which when executed by a processor, cause a computing system to at least:
store, at a database, historical location data associated with one or more transactions;
dynamically update the database with Wi-Fi Access Point Signal information and information from at least one external source, wherein the information is associated with a plurality of transaction characteristics associated with the one or more transactions;
establish a remote connection with an application program interface operating on a user device;
send, by the application programming interface, a raw data stream indicative of a transaction initiated via one or more user operations entered via the user device;
transform the raw data stream to a format for storage in a transaction lake, wherein the format enables accessibility by at least one verification process calling the transaction lake;
generate a device fingerprint and a set of transaction characteristics associated with the transformed data in the transaction lake, wherein the set of transaction characteristics comprises one or more of the plurality of transaction characteristics;
in response to generating the device fingerprint, establish a remote connection with the database to acquire and store, in the transaction lake, at least Wi-Fi Access Point Signal information for the user device associated with the transaction information; and
execute a verification process that calls the transaction lake to acquire data for assessing a transaction characteristic from the set of transaction characteristics, wherein the verification process comprises:
generate a set of verification scores, each verification score being indicative of a spoofing metric associated with the transaction characteristic, wherein a first verification score is determined using a first machine learning model determining location anomalies based on the Wi-Fi Access Point Signal information and the transaction information;
apply a second machine learning model trained to analyze the set of verification scores, to generate a transaction score indicative of a fraudulent transaction prediction;
re-train the first machine learning model based on the transaction score and the information from at least one external source; and
re-train the second machine learning model using the transaction score and the transaction information.

20. The non-transitory computer-readable storage medium of claim 19, wherein the transaction characteristic is at least one of IP data, Wi-Fi data, Wi-Fi Access Point Signal data, application data, sensor data, atmospheric pressure data, altitude data, satellite data, fingerprinting data, and fraudulent transaction data.
